(19) United States
(12) Patent Application Publication
(10) Pub. No.: US 2005/0248074 A1
(43) Pub. Date: Nov. 10, 2005

(54) Bar clamp with adjustable angle jaw pads

(76) Inventor: Bianca R. Ray Avalani, Princeton, NJ (US)

Correspondence Address: Kenneth P. Glynn, Esq.;Glynn & Associates, P.C., 24 Mine Street, Flemington, NJ, 08822, US

(21) Appl. No.: 10/842,121

(22) Filed: May 10, 2004

(51) Int. Cl. B25B 1/00

(52) U.S. Cl. 269/6

(57) ABSTRACT

A bar clamp with adjustable jaw pads for clamping and for spreading work pieces includes a main housing having a bar opening for extending a bar therethrough, and a bar advancing mechanism with a bar gripping member in proximity to the bar opening. There is an elongated slide bar extending through the bar opening, and a handle and trigger connected to the main housing wherein the trigger is connected to the bar advancing mechanism such that activation of the trigger causes advancement of the bar through the main housing. It also includes a first jaw base connected to the main housing and extending upwardly therefrom. A first jaw pad is rotatably connected to the first jaw base, so as to adjust an angle between the elongated slide bar and the first jaw pad. A separate, second jaw base is connected to the elongated slide bar. There is a second jaw pad rotatably connected to the second jaw base, so as to adjust an angle between the elongated slide bar and the second jaw pad.

### BACKGROUND OF THE INVENTION

1. Field of the Invention

The present invention relates to adjustable bar clamps that provide moveable jaws that may be tightened toward one another for clamping a work piece and may be tightened against a work piece in a spreading fashion. The present invention bar clamps provide for adjustable angle opposing jaw pads. These jaw pads may be free-floating, and, hence, will be self-adjusting; they may be free-floating with a locking means at each jaw to maintain angles to which the jaws had self-adjusted; or they may be rotatable for selection and locking of an angle at each jaw.

2. Information Disclosure Statement

The following prior art is representative of the state of the art in the field of bar clamp systems:

U.S. Pat. No. 5,009,134 describes a bar clamp having a fixed jaw and a movable jaw which is radially movable over both short and long distances to clamp against a workpiece and operable using one hand with complete control by the operator at all times. The jaws may either face one another while being mounted on the same side of a handle/grip assembly or face in opposite directions while being mounted on opposite side of the handle/grip assembly whereby they may be incrementally advanced by the trigger handle/driving lever.

U.S. Pat. No. 5,022,137 describes a bar clamp, which is operable with one hand and includes a fixed jaw and a movable jaw. The movable jaw connects at one end to a movable slide bar. One-way drive means, by operation of a trigger handle grip, releasably engages the slide bar and advances the movable jaw toward the fixed jaw. Return motion of the movable jaw is accomplished manually when the one-way drive means is disengaged. A braking lever, biased to bind against the slide bar, prevents reverse motion of the movable jaw except when disengaged from the slide bar. The trigger handle advances the slide bar by driving a second lever which binds against a slide bar surface. The second lever returns by spring force to its original position after each stroke of the trigger handle.

U.S. Pat. No. 5,853,168 describes a bar clamp for single hand operation. It includes a housing, a fixed jaw and a movable jaw mounted on one end of a slide bar for movement in a direction toward the fixed jaw. A spring-loaded driving key is secured on the slide bar and through operation of a trigger handle engages the slide bar for advancing the movable jaw toward the fixed jaw. A locking key is biased against the slide bar and normally engaged with the slide bar to prevent motion of the second jaw away from the first jaw and actuatable to disengage from the slide bar to allow advancement of the second jaw away from the first jaw. The trigger handle has one end pivotably mounted within the housing and formed with two lateral mounting plates of arched outer configuration. The housing is comprised of a first housing portion and a second housing portion, with at least the driving key and the locking key being accommodated within the housing. The first housing portion has formed on an inside wall thereof a first support member for surrounding one of the mounting plates, and the second housing portion includes a second support member formed on an inside lo wall of the second housing portion for receiving the other one of the mounting plates.

U.S. Pat. No. 6,382,608 B1 describes an adjustable clamping and spreading bar clamp or bench vice that includes a fixed jaw and a movable jaw opposing the fixed jaw, where the fixed jaw and the movable jaw each include two jaw pads facing in opposite directions. The movable jaw connect at one end to a slide bar, which is movable to bring the movable jaw toward and away from the fixed jaw, the movable jaw includes means to releasably engages the slide bar and advances the movable jaw toward the fixed jaw or moves the movable jaw away from the fixed jaw for spreading or jacking. A two-way drive means is operational by a trigger handle grip. Also included is a pair of mechanical detent switches, which are rotated approximately ¼ revolution, to either change the direction of the movable jaw, or release the clamp after either clamping or spreading.

U.S. Pat. No. 6,386,530 B1 describes a bar clamp operated by squeezing a handle to close a jaw. The improvements of the invention include: low actuation force, two speed action to provide both high speed closing and high force clamping, a removable bar to allow different length bars to be installed into one body, a side mounted bar release button which allows easy access and an increased handle stroke, and reinforced wedge elements.

U.S. Pat. No. 6,412,767 B1 describes a method of attaching a clamping jaw to a support element comprising a stop element having the steps of positioning a stop element within a channel formed in the clamping jaw and blocking a first end of the channel and a second end of the channel so that the stop element is trapped between the first and second ends of the channel.

Notwithstanding the prior art, the present invention is neither taught nor rendered obvious thereby.

### SUMMARY OF THE INVENTION

The present invention relates to a bar clamp with adjustable jaw pads for clamping and for spreading work pieces. It includes a main housing having a bar opening for extending a bar therethrough, and a bar advancing mechanism with a bar gripping member in proximity to the bar opening. There is an elongated slide bar extending through the bar opening of the main housing for relative movement of the bar through the main housing, and a handle and trigger connected to the main housing wherein the trigger is connected to the bar advancing mechanism of the main housing such that activation of the trigger causes advancement of the bar through the main housing. The main housing internal mechanisms for moving, locking, and unlocking are well known and within the abilities of the artisan. The prior art cited above illustrates various internal movement, hold and release mechanisms that may be employed in the main housing of the present invention.

The present invention also includes a first jaw base connected to the main housing and extending upwardly therefrom. A first jaw pad is rotatably connected to the first jaw base, and is rotatable so as to adjust an angle between the elongated slide bar and the first jaw pad.

A separate, second jaw base is connected to the elongated slide bar, and this connection may be fixed or moveable, and moveable preferred. There is a second jaw pad rotatably connected to the second jaw base, and it is rotatable so as to adjust an angle between the elongated slide bar and the second jaw pad.

When the second jaw base is moveably connected to the elongated slide bar, it is preferably lockable on the elongated slide bar, and the second jaw base includes a lock means and a release means. This lock means and release means may be a friction lock with a spring biased release mechanism.

While the jaw pads of the present invention are generally flat, and are illustrated herein as flat, they may have a three dimensional topography (e.g. with serration), and/or be curvilinear in one or two planes, so as to accommodate non-flat work pieces.

In some preferred embodiments, the second jaw base is removable from and directionally reversible relative to the elongated slide bar so that it is convertible from a clamping to a spreading device. When it is removed and reversed it may be attached to the elongated slide bar on the opposite end of the elongated slide bar so that the jaw pad is away from and faces opposite from the first jaw pad to create the spreading feature. Alternatively, one or both of the jaw pads may be flipped over the top of its base to face a generally opposite direction to shift from clamping to spreading and vice versa.

In some preferred embodiments, at least one of the first jaw pad and the second jaw pad, and preferably both, includes a jaw pad lock and release mechanism for selectively maintaining an angle between it and its base, and hence the elongated slide bar. The jaw pad lock and release mechanism may include a rotating, threaded lock that may be rotated in a first direction to lock a jaw pad at a selected angle, and rotated in a second, opposite direction to unlock said jaw pad.

In other preferred embodiments, at least one of the first jaw pad and the second jaw pad includes an angle selection and lock mechanism. The angle selection and lock mechanism may include a ratchet and gear mechanism to enable finer selection of angle. A calibration or angle scale could be shown on the side of or on a dial to further improve angle selection.

### BRIEF DESCRIPTION OF THE DRAWINGS

The present invention should be more fully understood when the specification herein is taken in conjunction with the drawings appended hereto wherein:

FIG. 1 illustrates a side view of a present invention bar clamp device;

FIG. 2 shows a partial top view of the present invention device shown in FIG. 1;

FIGS. 3 and 4 show side views of the present invention device of FIGS. 1 and 2 above, but in use with clamping and with spreading work pieces, respectively;

FIGS. 5 and 6 show partial side views of a jaw of the present invention device to illustrate extreme opened and closed angles for the embodiment shown in the previous Figures; and,

FIGS. 7 and 8 show side views of lockable and rotatable jaw pad angles.

### DETAILED DESCRIPTION OF THE PRESENT INVENTION

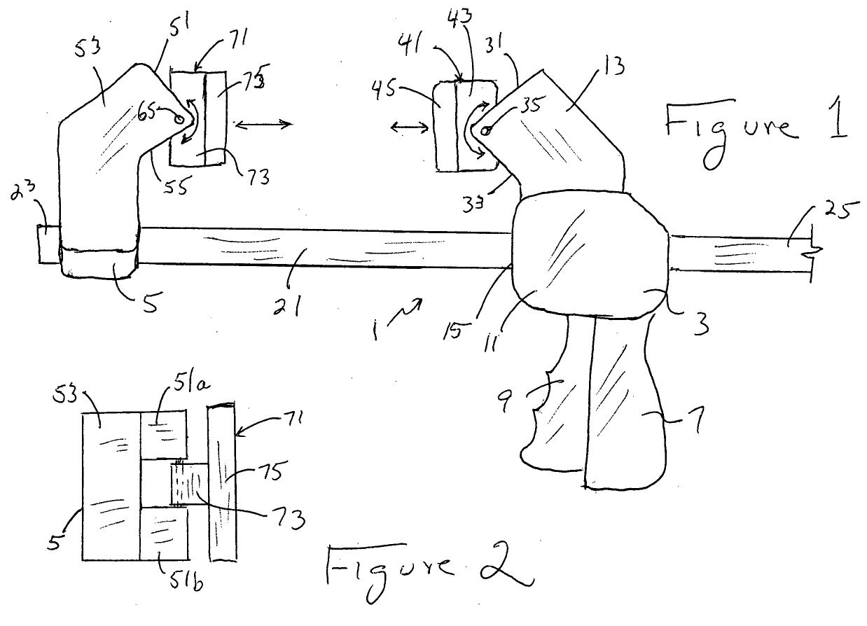

FIG. 1 illustrates a side view of a present invention bar clamp device 1. It includes a main housing 3 with an outer casing 11 and has a bar advancing mechanism with a bar gripping member inside. This mechanism is conventional, as mentioned above. The main housing 3 has a handle 7 and a trigger 9 for holding the device and activating a release/bar advancing mechanism. There is a bar opening 15 that extends through main housing 3, and has the configuration to receive and hold elongated slide bar 21, as shown. Atop main housing 3 and extending upwardly therefrom is first jaw base 13. It has a front 33 and a top 31. Rotatably connected to it is first jaw pad 41, having a support member 43, a compression member 45 and a rotational pin 35. Axle pin 35 is connected to the support member 43 and the jaw base 13 so that the jaw pad 41 may freely rotate about the pin 35 to adjust the angle between the jaw pad 41 and the jaw base 13 (and hence the angle between the jaw pad 41 and the elongated slide bar 21, since the angle between the jaw base 13 and the bar 21 is fixed). This rotation is about an axis that is perpendicular to the axis of movement (elongated central axis of movement) of the elongated slide bar 21.

There is a second jaw base 5 that is connected directly to elongated slide bar 21, as shown. This could be fixedly attached, but is preferably movably, removably and reversibly attached to the elongated slide bar 21. For example, it may include a spring biased release lock that is depressed for movement of this second jaw base 5.

Second jaw base 5 has an upper portion 53 with a top 51 and a front 55. There is a second jaw pad 71 that has a support member 73 and a compression member 75. Support member 73 is rotatably connected to second jaw base 5 via axle pin 65 and renders the jaw apd 71 movable about an axis that is perpendicular to the elongated central axis of movement of the elongated slide bar 21.

Inside the main housing 3 and adjacent the bar opening 15 is the aforesaid mechanism for the locking, releasing and advancing of the bar. In the case of FIG. 1, each time a user pulls trigger 9, bar 21 will advance to the right, and right bar end 25 will move away from main housing 3 (with left end 23 and thus second jaw base 5, moving toward it).

FIG. 2 shows a partial top view of the present invention device second jaw base 5 and second jaw pad 71 shown in FIG. 1. It is seen that the top of base 5 has two halves 51a and 51b; otherwise identical parts are identically numbered.

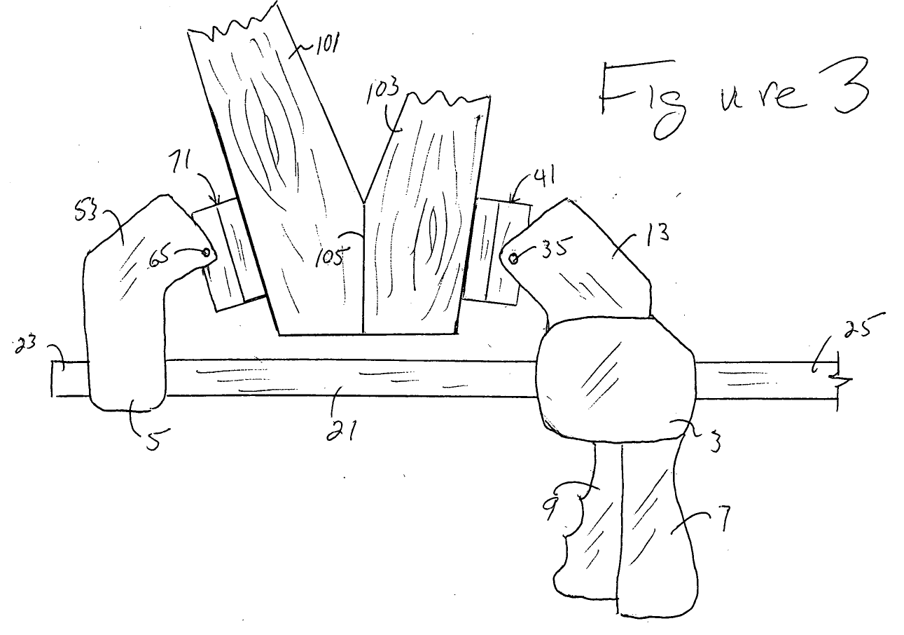

FIGS. 3 and 4 show side views of the present invention device of FIGS. 1 and 2 above, but in use with clamping and with spreading work pieces, respectively. Again, identical parts are identically numbered.

As FIG. 3 shows, jaw pads 41 and 71 are clamping work pieces 101 and 103 that do not have parallel outer sides and cannot be clamped with a conventional bar clamp. Here, the jaw pads adjust to the appropriate angles and provide surface-to-surface contact, non-parallel clamping. In this Figure, the work pieces 101 and 103 are being biscuit connected and glued together at joint 105.

As FIG. 4 shows, the reversal of jaw pad 5 and reconnection to the bar 21 at the opposite end 25, creates a spreading arrangement, such as for expanding the distance between connected work pieces, as the insides of panels to a cabinet that is being glued from the inside. In this Figure, the jaw pads 41 and 71 are facing away from each other for the spreading function.

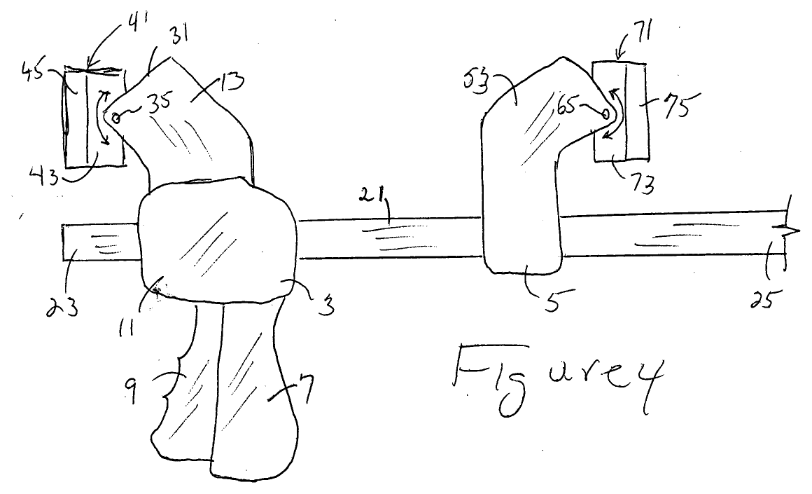

FIGS. 5 and 6 show partial side views of a jaw of the present invention device to illustrate extreme opened and closed angles for the embodiment shown in the previous Figures. In FIG. 5, jaw pad 71 is tilted upward to wide angle, and in FIG. 6 it is tilted downward to a very narrow angle. In FIG. 6, jaw pad 71 is actually clamping a work piece 90 to the slide bar 21.

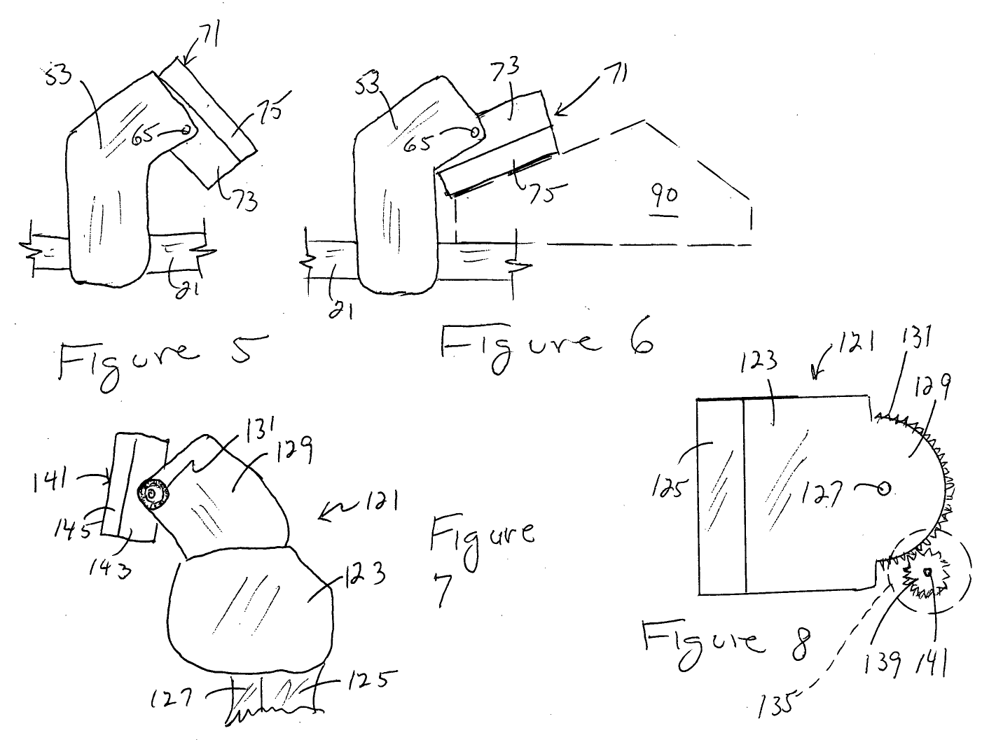

FIGS. 7 and 8 show side views of lockable and rotatable jaw pad angles.

In FIG. 7, a partial side view of portion of a present invention device 121. Its main housing 123 would be used, for example, in place of main housing 3 and all of its accoutrements shown in FIG. 1 on bar 21. Main housing 123 has a handle 125 and a trigger 129, as well as a first jaw base 129. Floating jaw pad 141 with compression member 145 and support 143, may be free-floating to auto adjust to the angle of a work piece, and subsequently locked into that angle by locking dial 131. Dial 131 would rotate down to tighten and up to loosen the jaw pad 141 relative to the base 129.

In an alternative present invention device 121 of FIG. 8, the angle may be set and then the work piece can be inserted at the pre-selected and preset angle. This diagrammatic representation shows jaw pad compression member 125 and jaw pad support member 123 with an axle pin 127 connected to a jaw base (not shown). It includes an arc of ratchets 131 geared to circular gear 139 on dial 135, rotating on pin 141. Dial 135 is a resistance dial and could include indicia for seting concise angles. A user would dial the angle it would remain there due to the resistance or it could have a lock-unlock feature to maintain a tight, strong angle position.

Obviously, numerous modifications and variations of the present invention are possible in light of the above teachings. It is therefore understood that within the scope of the appended claims, the invention may be practiced otherwise than as specifically described herein.

1. A bar clamp with adjustable jaw pads for clamping and for spreading work pieces, which comprises:
(a.) a main housing having a bar opening for extending a bar therethrough, and a bar advancing mechanism with a bar gripping member in proximity to said bar opening;
(b.) an elongated slide bar extending through said bar opening of said main housing for relative movement of said bar through said main housing;
(c.) a handle and trigger connected to said main housing wherein said trigger is connected to said bar advancing mechanism of said main housing such that activation of said trigger causes advancement of said bar through said main housing;
(d.) a first jaw base connected to said main housing and extending upwardly therefrom;
(e.) a first jaw pad rotatably connected to said first jaw base, being rotatable so as to adjust an angle between said elongated slide bar and said first jaw pad;
(f.) a second jaw base connected to said elongated slide bar; and,
(g.) a second jaw pad rotatably connected to said second jaw base, being rotatable so as to adjust an angle between said elongated slide bar and said second jaw pad.

2. The bar clamp with adjustable jaw pads for clamping and for spreading work pieces of claim 1 wherein said second jaw base is fixedly connected to said elongated slide bar.

3. The bar clamp with adjustable jaw pads for clamping and for spreading work pieces of claim 1 wherein said second jaw base is moveably connected to said elongated slide bar.

4. The bar clamp with adjustable jaw pads for clamping and for spreading work pieces of claim 3 wherein said second jaw base is lockable on said elongated slide bar, and said second jaw base includes a lock means and a release means.

5. The bar clamp with adjustable jaw pads for clamping and for spreading work pieces of claim 4 wherein said lock means and release means is a friction lock with a spring biased release mechanism.

6. The bar clamp with adjustable jaw pads for clamping and for spreading work pieces of claim 4 wherein said second jaw base is removable from and directionally reversible relative to said elongated slide bar.

7. The bar clamp with adjustable jaw pads for clamping and for spreading work pieces of claim 1 wherein at least one of said first jaw pad and said second jaw pad includes a jaw pad lock and release mechanism for selectively maintaining an angle between it and said elongated slide bar.

8. The bar clamp with adjustable jaw pads for clamping and for spreading work pieces of claim 7 wherein said jaw pad lock and release mechanism includes a rotating, threaded lock that may be rotated in a first direction to lock a jaw pad at a selected angle, and rotated in a second, opposite direction to unlock said jaw pad.

9. The bar clamp with adjustable jaw pads for clamping and for spreading work pieces of claim 1 wherein said at least one of said first jaw pad and said second jaw pad includes an angle selection and lock mechanism.

10. The bar clamp with adjustable jaw pads for clamping and for spreading work of claim 9 wherein said angle selection and lock mechanism includes a ratchet and gear mechanism.

11. A bar clamp with adjustable jaw pads for clamping and for spreading work pieces, which comprises:
(a.) a main housing having a bar opening for extending a bar therethrough, and a bar advancing mechanism with a bar gripping member in proximity to said bar opening;
(b.) an elongated slide bar having an elongated central axis and extending through said bar opening of said main housing along said elongated central axis for relative movement of said bar through said main housing;
(c.) a handle and trigger connected to said main housing wherein said trigger is connected to said bar advancing mechanism of said main housing such that activation of said trigger causes advancement of said bar through said main housing;
(d.) a first jaw base connected to said main housing and extending upwardly therefrom;
(e.) a first jaw pad rotatably connected to said first jaw base, being rotatable so as to adjust an angle between said elongated slide bar and said first jaw pad, said first jaw pad having a support member and a compression member, and said support member having a rotational axle connected to said first jaw base, said rotational axle having a rotational direction about an axis that is perpendicular to elongated central axis of said elongated slide bar;
(f.) a second jaw base connected to said elongated slide bar; and,
(g.) a second jaw pad rotatably connected to said second jaw base, being rotatable so as to adjust an angle between said elongated slide bar and said second jaw pad, said second jaw pad having a support member and a compression member, and said support member having a rotational axle connected to said second jaw base, said rotational axle having a rotational direction about an axis that is perpendicular to elongated central axis of said elongated slide bar.

12. The bar clamp with adjustable jaw pads for clamping and for spreading work pieces of claim 11 wherein said second jaw base is fixedly connected to said elongated slide bar.

13. The bar clamp with adjustable jaw pads for clamping and for spreading work pieces of claim 11 wherein said second jaw base is moveably connected to said elongated slide bar.

14. The bar clamp with adjustable jaw pads for clamping and for spreading work pieces of claim 13 wherein said second jaw base is lockable on said elongated slide bar, and said second jaw base includes a lock means and a release means.

15. The bar clamp with adjustable jaw pads for clamping and for spreading work pieces of claim 14 wherein said lock means and release means is a friction lock with a spring biased release mechanism.

16. The bar clamp with adjustable jaw pads for clamping and for spreading work pieces of claim 14 wherein said second jaw base is removable from and directionally reversible relative to said elongated slide bar.

17. The bar clamp with adjustable jaw pads for clamping and for spreading work pieces of claim 11 wherein at least one of said first jaw pad and said second jaw pad includes a jaw pad lock and release mechanism for selectively maintaining an angle between it and said elongated slide bar.

18. The bar clamp with adjustable jaw pads for clamping and for spreading work pieces of claim 17 wherein said jaw pad lock and release mechanism includes a rotating, threaded lock that may be rotated in a first direction to lock a jaw pad at a selected angle, and rotated in a second, opposite direction to unlock said jaw pad.

19. The bar clamp with adjustable jaw pads for clamping and for spreading work pieces of claim 11 wherein said at least one of said first jaw pad and said second jaw pad includes an angle selection and lock mechanism.

20. The bar clamp with adjustable jaw pads for clamping and for spreading work of claim 19 wherein said angle selection and lock mechanism includes a ratchet and gear mechanism.
